(19) United States
(12) Patent Application Publication
(10) Pub. No.: US 2018/0261374 A1
(43) Pub. Date: Sep. 13, 2018

(54) REACTOR, MOTOR DRIVER, POWER CONDITIONER AND MACHINE

(71) Applicant: Fanuc Corporation, Yamanashi (JP)

(72) Inventors: Kenichi Tsukada, Yamanashi (JP); Masatomo Shirouzu, Yamanashi (JP)

(73) Assignee: Fanuc Corporation, Yamanashi (JP)

(21) Appl. No.: 15/915,333

(22) Filed: Mar. 8, 2018

(30) Foreign Application Priority Data
Mar. 13, 2017 (JP) 2017-047182

(51) Int. Cl. H01F 27/08; H01F 27/24; H01F 27/28; H01F 27/02

(52) U.S. Cl. CPC H01F 27/08; H01F 27/025; H01F 27/28; H01F 27/24

(57) ABSTRACT

A reactor includes an outer peripheral iron core, and at least three core coils contacting or connected to an inner surface of the outer peripheral iron core. Each of the core coils includes a core and a coil wound onto the core. The reactor further includes cooling units disposed in end surfaces of the outer peripheral iron core, for cooling the outer peripheral iron core.

### BACKGROUND OF THE INVENTION

### 1. Field of the Invention

The present invention relates to a reactor, a motor driver, a power conditioner and a machine.

### 2. Description of Related Art

In general, reactors each have a plurality of cores and a plurality of coils wound onto the cores. In such reactors, when the coils magnetize the cores, an iron loss occurs which causes an increase in temperature.

Thus, Japanese Unexamined Patent Publication (Kokai) No. 2009-49082 discloses that “a reactor circulation path 64 is connected to the inside of a reactor case 32 of a reactor 30. The reactor case 32 contains cores 34 and coils 36, which constitute the reactor 30, and a coolant 66 circulates through space in the container.”

### SUMMARY OF THE INVENTION

However, since the reactor according to Japanese Unexamined Patent Publication (Kokai) No. 2009-49082 is disposed in the reactor case through which the coolant circulates, the structure is large.

Therefore, it is desired to provide a reactor that can be efficiently cooled with a simple structure without an increase in size, and a motor driver, a power conditioner and a machine having the reactor.

An embodiment of this disclosure provides a reactor that includes an outer peripheral iron core, and at least three core coils contacting or connected to an inner surface of the outer peripheral iron core. Each of the core coils includes a core and a coil wound onto the core. The reactor further includes a cooling unit which is disposed in an end surface of the outer peripheral iron core, for cooling the outer peripheral iron core.

According to the embodiment, since the cooling unit is disposed in the end surface of the outer peripheral iron core, the reactor can be efficiently cooled with a simple structure without an increase in size.

The above and other objects, features and advantages of the present invention will become more apparent from the following detailed description of preferred embodiments along with the accompanying drawings.

### BRIEF DESCRIPTION OF THE DRAWINGS

FIG. 1A is a top view of a reactor according to a first embodiment;

FIG. 1B is a side view of the reactor shown in FIG. 1A;

FIG. 2A is a first view showing the magnetic flux density of the reactor according to the first embodiment;

FIG. 2B is a second view showing the magnetic flux density of the reactor according to the first embodiment;

FIG. 2C is a third view showing the magnetic flux density of the reactor according to the first embodiment;

FIG. 2D is a fourth view showing the magnetic flux density of the reactor according to the first embodiment;

FIG. 2E is a fifth view showing the magnetic flux density of the reactor according to the first embodiment;

FIG. 2F is a sixth view showing the magnetic flux density of the reactor according to the first embodiment;

FIG. 3 is a graph showing the relationship between phase and current;

FIG. 4A is a top view of an outer peripheral iron core according to the first embodiment;

FIG. 4B is a top view of a reactor according to another embodiment;

FIG. 5 is a top view of an outer peripheral iron core of a reactor according to a second embodiment;

FIG. 6 is a top view of a reactor according to a third embodiment;

FIG. 7A is a top view of a reactor according to a fourth embodiment;

FIG. 7B is a drawing showing the magnetic flux density of the reactor according to the fourth embodiment;

FIG. 8 is a perspective view of a reactor according to a fifth embodiment;

FIG. 9 is a partly exploded perspective view of a reactor according to a sixth embodiment;

FIG. 10A is a perspective view of a reactor according to a seventh embodiment;

FIG. 10B is an enlarged view showing a part of the reactor shown in FIG. 10A;

FIG. 11A is a perspective view of a reactor according to an eighth embodiment;

FIG. 11B is another perspective view of the reactor shown in FIG. 11A;

FIG. 12 is a perspective view of a reactor according to a ninth embodiment; and

FIG. 13 is a block diagram of a machine including a reactor.

### DETAILED DESCRIPTION OF THE INVENTION

Embodiments of the present invention will be described below with reference to the accompanying drawings. In the drawings, the same reference numerals indicate the same components. For ease of understanding, the drawings have been modified in scale in an appropriate manner.

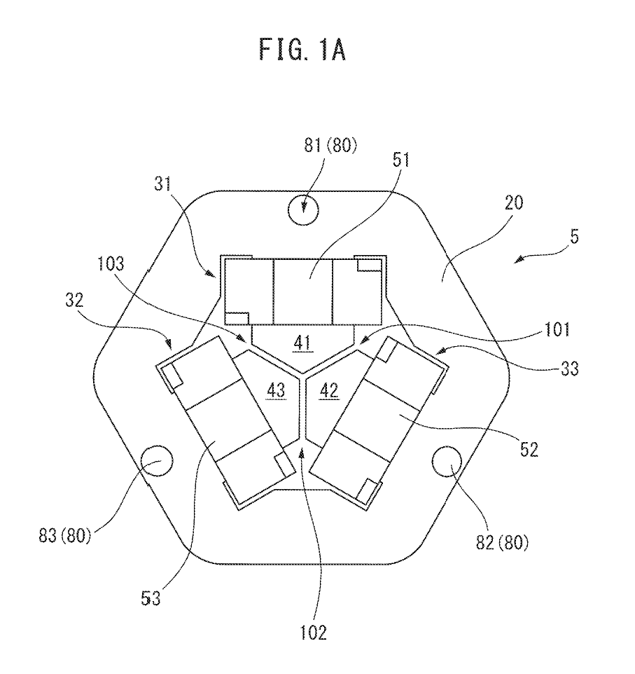

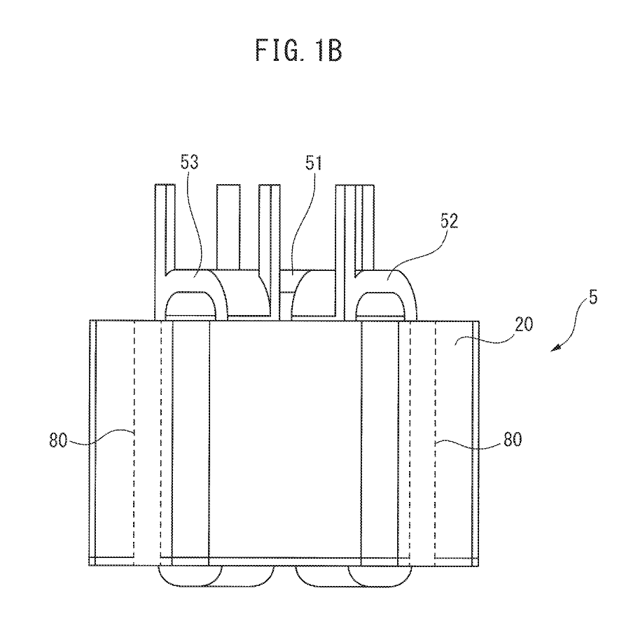

FIG. 1A is a top view of a reactor according to a first embodiment. As shown in FIG. 1A, a reactor 5 includes an outer peripheral iron core 20 having a round cross-section and at least three core coils 31 to 33 contacting or connected to an inner surface of the outer peripheral iron core 20. The number of cores is preferably an integral multiple of 3, and the reactor 5 can be thereby used as a three-phase reactor. The outer peripheral iron core 20 may be polygonal in shape. The core coils 31 to 33 are in contact or integral with the inner surface of the outer peripheral iron core 20.

The core coils 31 to 33 include cores 41 to 43 and coils 51 to 53 wound onto the cores 41 to 43, respectively. Each of the outer peripheral iron core 20 and the cores 41 to 43 is made by stacking iron sheets, carbon steel sheets or electromagnetic steel sheets, or made of ferrite, an amorphous material or a pressed powder core.

As shown in FIG. 1A, the cores 41 to 43 have approximately the same dimensions as each other, and are arranged at approximately equal intervals in the circumferential direction of the outer peripheral iron core 20. In FIG. 1A, the cores 41 to 43 contact or are connected to the outer peripheral iron core 20 at their radial outer end portions.

Furthermore, the cores 41 to 43 converge toward the center of the outer peripheral iron core 20 at their radial inner end portions each having an edge angle of approximately 120°. The radial inner end portions of the cores 41 to 43 are separated from each other by gaps 101 to 103, which can be magnetically coupled.

In other words, in the first embodiment, the radial inner end portion of the core 41 is separated from the radial inner end portions of the two adjacent cores 42 and 43 by the gaps 101 and 103, respectively. The same is true for the other cores 42 and 43. The gaps 101 to 103 ideally have the same dimensions, but may have different dimensions. In embodiments described later, a description regarding the gaps 101 to 103, the core coils 31 to 33, and the like may be omitted.

As described above, in the first embodiment, the core coils 31 to 33 are disposed inside the outer peripheral iron core 20. In other words, the core coils 31 to 33 are enclosed with the outer peripheral iron core 20. The outer peripheral iron core 20 can reduce leakage of magnetic flux generated by the coils 51 to 53 to the outside.

Furthermore, in the first embodiment, at least one cooling unit, for example, three cooling units 80, are disposed in the outer peripheral iron core 20, as shown in FIG. 1A. The cooling units 80 cool the inside of the outer peripheral iron core 20, in particular the coils 51 to 53. Since the cooling units 80 are laid out in the area of the outer peripheral iron core 20, the reactor 5 can be efficiently cooled with a simple structure when the reactor 5 is driven.

FIG. 1B is a side view of the reactor shown in FIG. 1A. Each cooling unit 80 is constituted of a through hole (FIG. 1B) formed so as to extend in an axial direction of the outer peripheral iron core 20. When the reactor 5 is driven, heat dissipates through the through holes, thus cooling the reactor 5 with high efficiency.

As a non-illustrated embodiment, a single cooling unit 80 may be formed in the area of the outer peripheral iron core 20. The cooling unit 80 need not necessarily have a circular cross-section, but may have an arcuate or rectangular cross-section extending in the circumferential direction of the outer peripheral iron core 20.

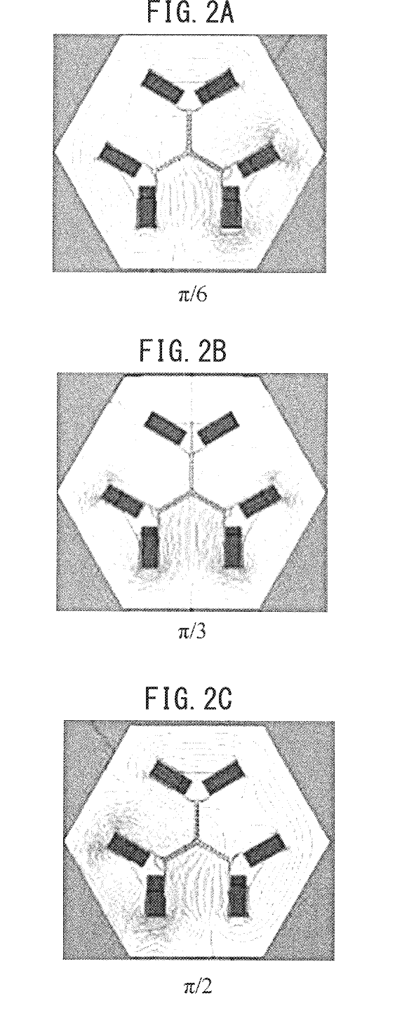

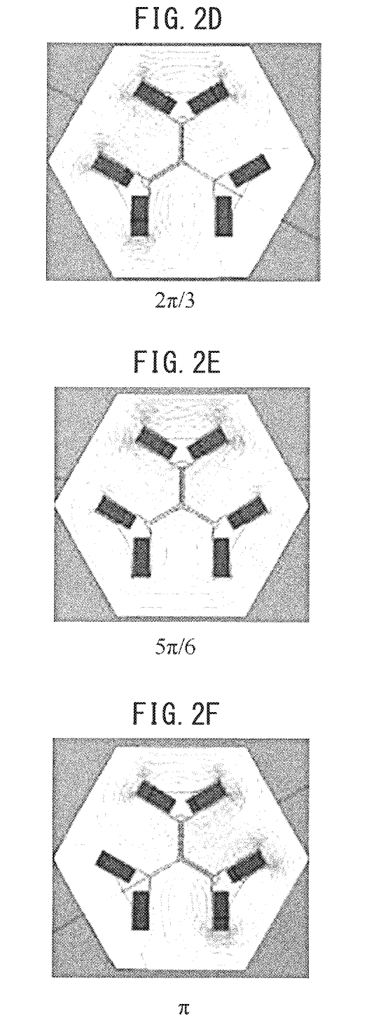

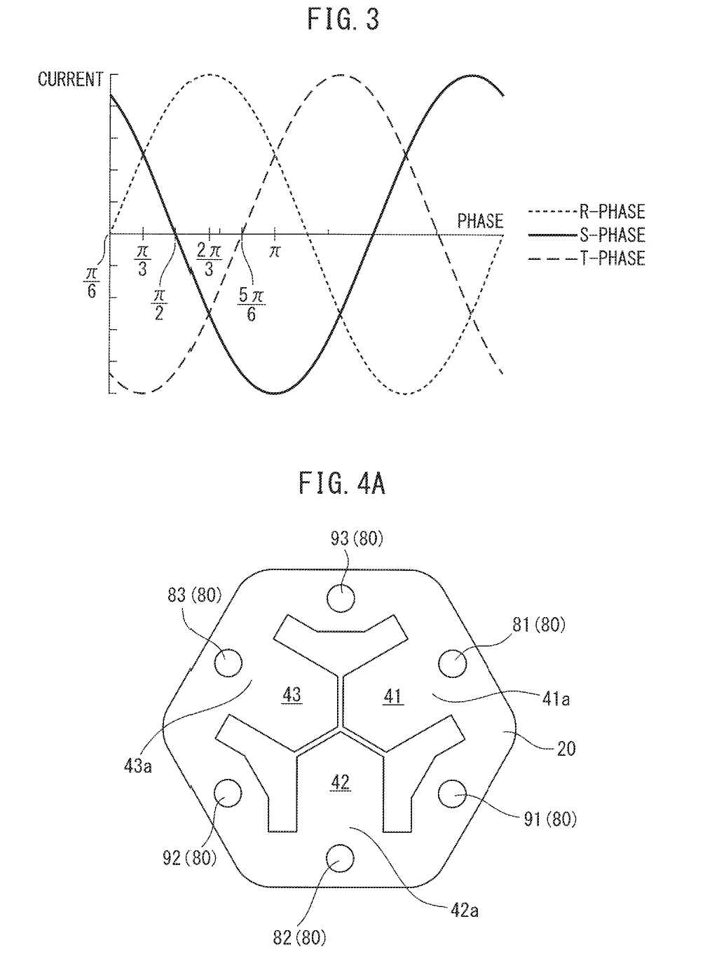

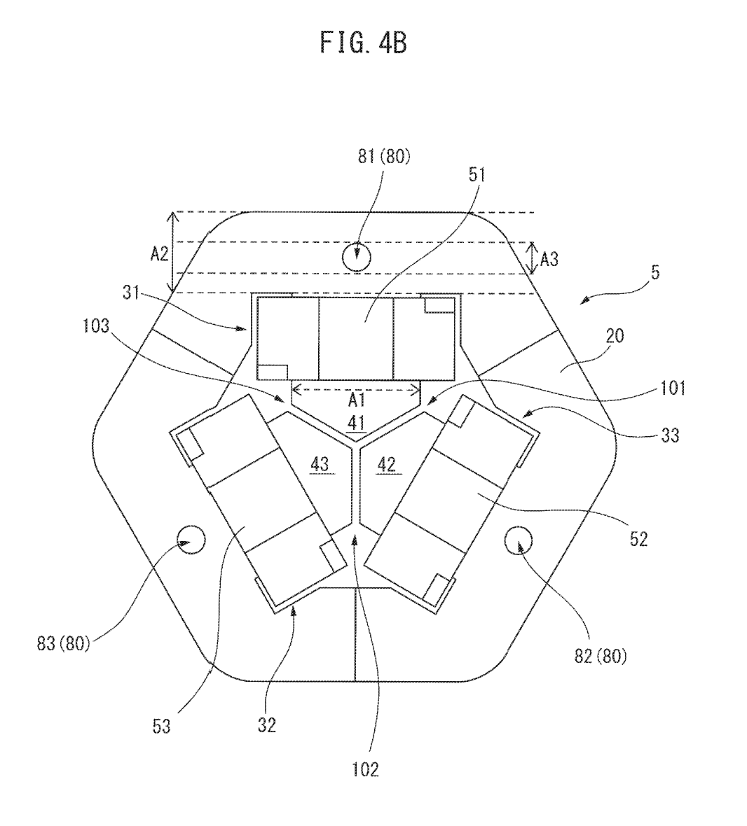

FIGS. 2A to 2F are drawings showing the magnetic flux density of the reactor according to the first embodiment. FIG. 3 is a graph showing the relationship between phase and current. FIG. 4A is a top view of the outer peripheral iron core according to the first embodiment. In FIG. 3, the cores 41 to 43 of the reactor 5 are assigned to an R-phase, an S-phase and a T-phase, respectively. In FIG. 3, the dotted line represents the R-phase current. The solid line represents the S-phase current. The dashed line represents the T-phase current.

When the electrical angle is π/6 in FIG. 3, a magnetic flux density as shown in FIG. 2A is obtained. In the same manner, when the electrical angle is π/3, a magnetic flux density as shown in FIG. 2B is obtained. When the electrical angle is π/2, a magnetic flux density as shown in FIG. 2C is obtained. When the electrical angle is 2π/3, a magnetic flux density as shown in FIG. 2D is obtained. When the electrical angle is 5π/6, a magnetic flux density as shown in FIG. 2E is obtained. When the electrical angle is π, a magnetic flux density as shown in FIG. 2F is obtained.

As is apparent from FIGS. 2A to 2F and FIG. 4A, the magnetic flux density is lower in outer end portion correspondence positions 81 to 83, which correspond to the radial outer end portions 41a to 43a of the cores 41 to 43, respectively, of the outer peripheral iron core 20 than in the remaining portions of the outer peripheral iron core 20. This is because less magnetic flux passes through the outer end portion correspondence positions 81 to 83. In the same manner, the magnetic flux density is lower in intermediate positions 91 to 93 between the outer end portion correspondence positions 81 to 83 along the outer peripheral iron core 20 than in the remaining portions of the outer peripheral iron core 20. Therefore, the cooling unit 80 is preferably disposed in at least one of the outer end portion correspondence positions 81 to 83 and the intermediate positions 91 to 93. In this case, the reactor 5 can be cooled without having adverse effects on the magnetic characteristics of the reactor 5. It is preferable that the width (radial distance) of the outer peripheral iron core 20, which has the cooling units 80 in the outer end portion correspondence positions 81 to 83 and the intermediate positions 91 to 93, be sufficiently wide. To be more specific, the remainder obtained by subtracting the radial distance of the cooling unit 80 disposed in each of the outer end portion correspondence positions 81 to 83 and the intermediate positions 91 to 93 from the width of the outer peripheral iron core 20 is preferably more than the radial distance of the cooling unit 80. This reliably provides an area through which the magnetic flux can pass, even when the cooling units 80 are disposed in the outer end portion correspondence positions 81 to 83 and the intermediate positions 91 to 93.

FIG. 4B is a top view of a reactor according to another embodiment. In FIG. 4B, a through hole constituting a cooling unit 80 is formed at approximately the center of a minimum width A2 of an outer peripheral iron core 20 in each of outer end portion correspondence positions 81 to 83. A3 denotes the diameter of the through hole constituting the cooling unit 80 formed in the outer end portion correspondence position 81. The remainder obtained by subtracting the diameter A3 of the through hole constituting the cooling unit 80 from the minimum width A2 of the outer peripheral iron core 20 (=A2−A3) is more than half of the width A1 of a core 41. In other words, even if the through hole is formed as the cooling unit 80, the width of the outer peripheral iron core 20 is relatively wide. This allows the outer peripheral iron core 20 to have a cross-sectional area through which the magnetic flux can pass. Therefore, the cooling unit 80 has no effect on the magnetic characteristics of the reactor 5. The same is true for the other outer end portion correspondence positions 82 and 83.

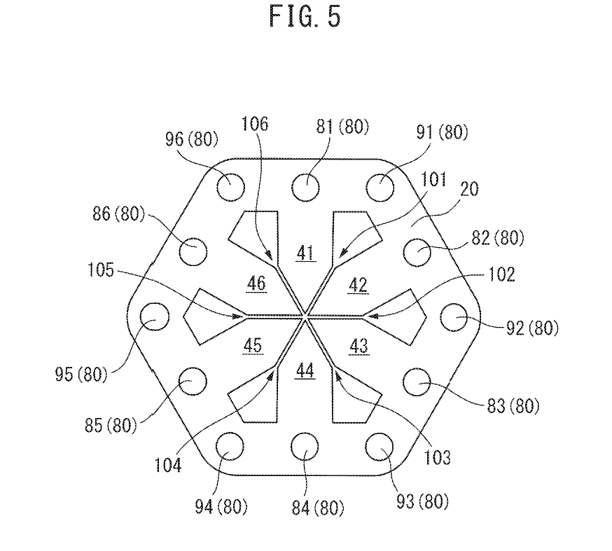

FIG. 5 is a top view of an outer peripheral iron core of a reactor according to a second embodiment. In FIG. 5, a reactor 5 includes an outer peripheral iron core 20 and six core coils 31 to 36 contacting or connected to an inner surface of the outer peripheral iron core 20. The core coils 31 to 36 include cores 41 to 46 and coils 51 to 56 wound onto the cores 41 to 46, respectively. As shown in the drawing, the core coils 31 to 36 are arranged at approximately equal intervals in the circumferential direction of the outer peripheral iron core 20. The cores 41 to 43 are separated from each other at their radial inner end portions by gaps 101 to 106, which can be magnetically coupled.

For the same reason as described above with reference to FIGS. 2A to 2F, a cooling unit 80 is preferably disposed in at least one of outer end portion correspondence positions 81 to 86 and intermediate positions 91 to 96 of the reactor 5, as shown in FIG. 5. In this case, it is apparent that the same effects as described above can be obtained.

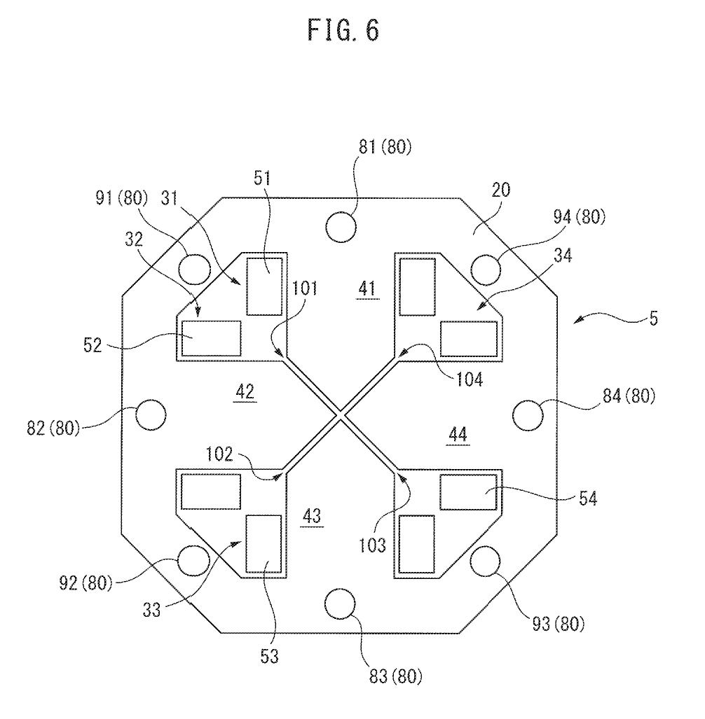

Furthermore, FIG. 6 is a top view of a reactor according to a third embodiment. In FIG. 6, a reactor 5 includes an approximately octagonal outer peripheral iron core 20 and four core coils 31 to 34 contacting or connected to an inner surface of the outer peripheral iron core 20 in the same manner as described above. The core coils 31 to 34 are arranged at approximately equal intervals in the circumferential direction of the reactor 5. The number of cores is preferably an even number more than 4, and the reactor 5 can be thereby used as a single-phase reactor.

As is apparent from the drawing, the core coils 31 to 34 include cores 41 to 44 extending in the radial direction and coils 51 to 54 wound onto the cores 41 to 44, respectively. The cores 41 to 44 are in contact or integral with the outer peripheral iron core 20 at their radial outer end portions.

Furthermore, radial inner end portions of the cores 41 to 44 are disposed in the vicinity of the center of the outer peripheral iron core 20. In FIG. 6, the cores 41 to 44 converge toward the center of the outer peripheral iron core 20 at their radial inner end portions each having an edge angle of approximately 90°. The radial inner end portions of the cores 41 to 44 are separated from each other by gaps 101 to 104, which can be magnetically coupled.

For the same reason as described above with reference to FIGS. 2A to 2F, a cooling unit 80 is preferably disposed in at least one of outer end portion correspondence positions 81 to 84 and intermediate positions 91 to 94 of the reactor 5, as shown in FIG. 6. In this case, it is apparent that the same effects as described above can be obtained.

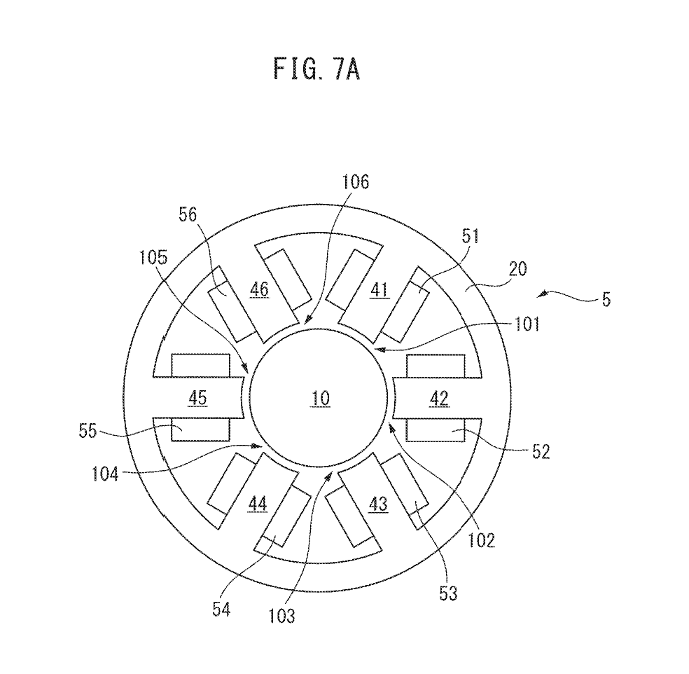

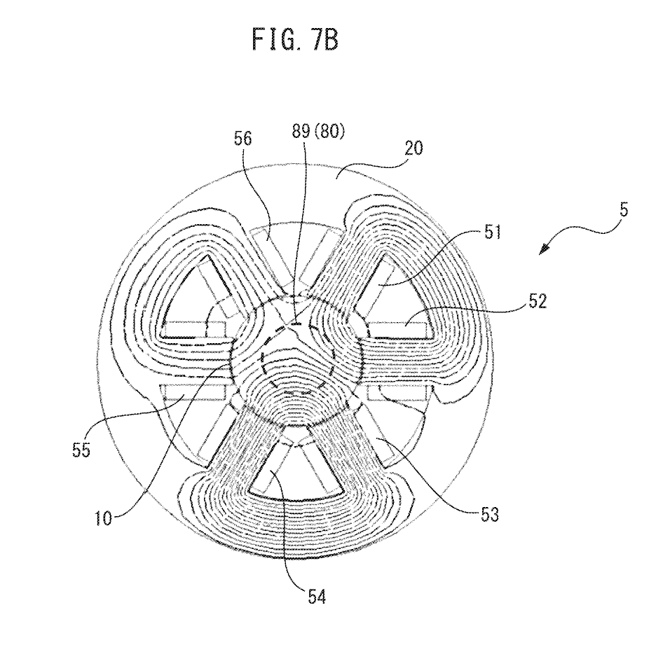

Furthermore, FIG. 7A is a top view of a reactor according to a fourth embodiment. In FIG. 7A, a reactor 5 includes a round outer peripheral iron core 20 and six core coils 31 to 36. The core coils 31 to 36 include cores 41 to 46 and coils 51 to 56 wound on the cores 41 to 46, respectively. The cores 41 to 46 are in contact or integral with an inner surface of the outer peripheral iron core 20. A central core 10 is disposed at the center of the outer peripheral iron core 20. The central core 10 is formed in the same manner as the outer peripheral iron core 20. Each of gaps 101 to 106, through which magnetic connection can be established, is formed between each of radial inner end portions of the cores 41 to 46 and the central core 10.

FIG. 7B is a drawing showing the magnetic flux density of the reactor according to the fourth embodiment. As is apparent from FIG. 7B, the magnetic flux density is lower in the central position 89 of the central core 10 than in the outer peripheral iron core 20 and the cores 41 to 46. Therefore, when the reactor 5 includes the central core 10, a through hole is preferably disposed in the central position 89 of the central core 10 as a cooling unit 80, in the same manner as described above. Therefore, the reactor 5 can be cooled without having adverse effects on the magnetic characteristics of the reactor 5 having the central core 10.

A plurality of cooling units 80 may be provided in the central core 10. The reactor 5 according to the fourth embodiment may have cooling units 80 in outer end portion correspondence positions and intermediate positions, in the same manner as described above.

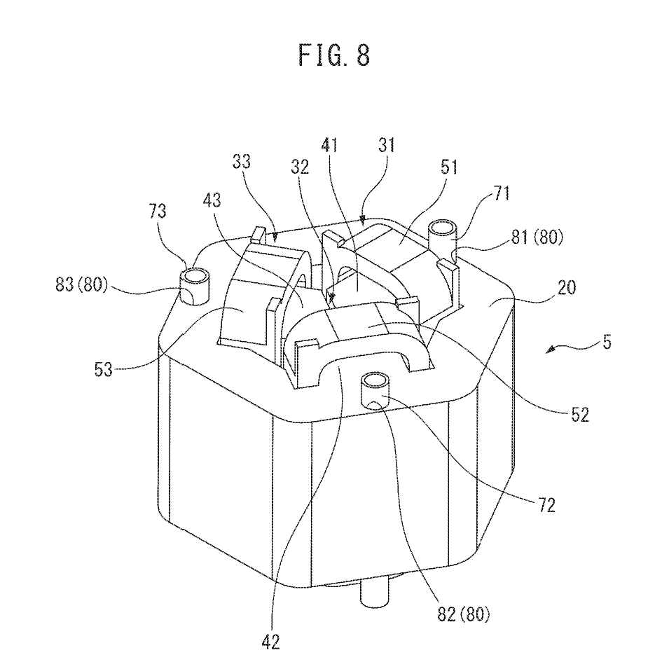

Cooling units 80 of a reactor 5 having three core coils 31 to 33 will be described below in detail. FIG. 8 is a perspective view of a reactor according to a fifth embodiment. In FIG. 8, each cooling unit 80 includes a through hole formed in each of outer end portion correspondence positions 81 to 83. The cooling unit 80 further includes tubes 71 to 73 inserted into each through hole. The tubes 71 to 73 are preferably cooling pipes made of a material having a higher thermal conductivity than material of the outer peripheral iron core 20.

In this case, heat dissipates through the tubes 71 to 73, thus cooling the reactor 5 with high efficiency. Furthermore, coolant flowing from a non-illustrated coolant supply through the inside of the tubes 71 to 73 further enhances the cooling effect.

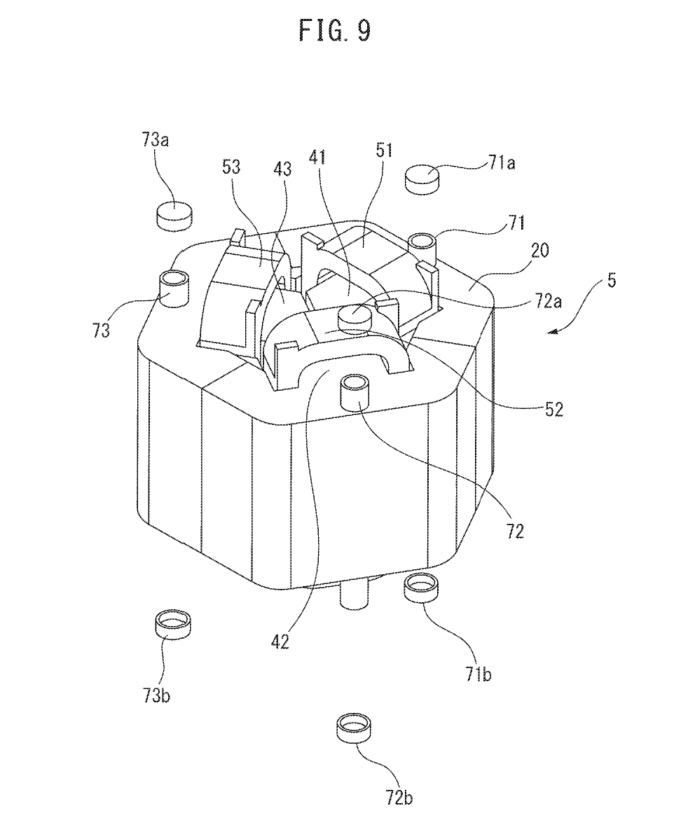

FIG. 9 is a partly exploded perspective view of a reactor according to a sixth embodiment. In FIG. 9, lids 71a to 73a and 71b to 73b are fitted over both ends of tubes 71 to 73. After the lids 71b to 73b are fitted over one ends of the tubes 71 to 73, the tubes 71 to 73 are supplied with coolant. After that, the other lids 71a to 73a are fitted over the tubes 71 to 73 to close the tubes 71 to 73, respectively. In this case, the reactor 5 can be cooled with higher efficiency. This eliminates the need for providing a coolant supply, thus preventing an increase in structure size.

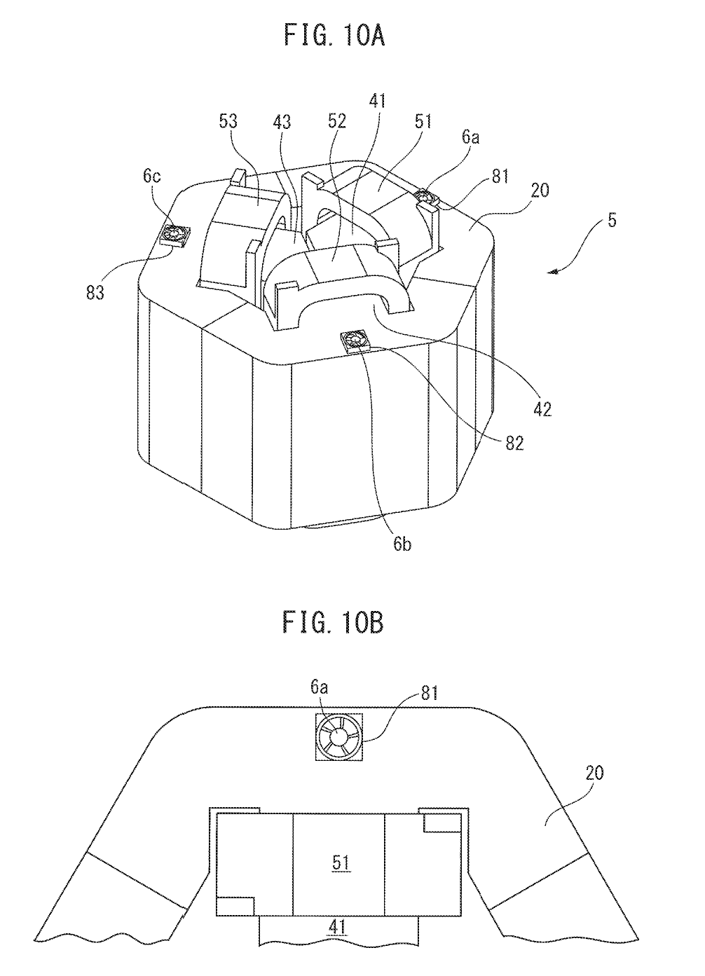

FIG. 10A is a perspective view of a reactor according to a seventh embodiment, and FIG. 10B is an enlarged view showing a part of the reactor shown in FIG. 10A. In the drawings, cooling fans 6a to 6c are attached to inlets of through holes formed in outer end portion correspondence positions 81 to 83, respectively. The cooling fans 6a to 6c and a cooling fan 6 described later are driven by non-illustrated motors. The same cooling fans may be attached to the inlets of through holes and the like formed in intermediate positions 91 to 93.

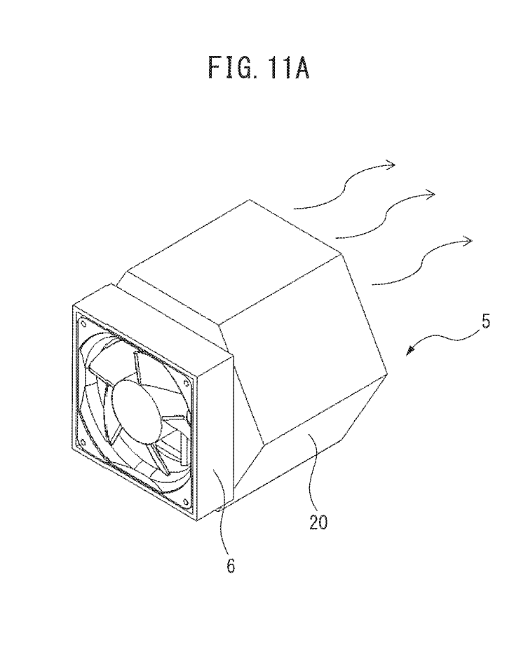

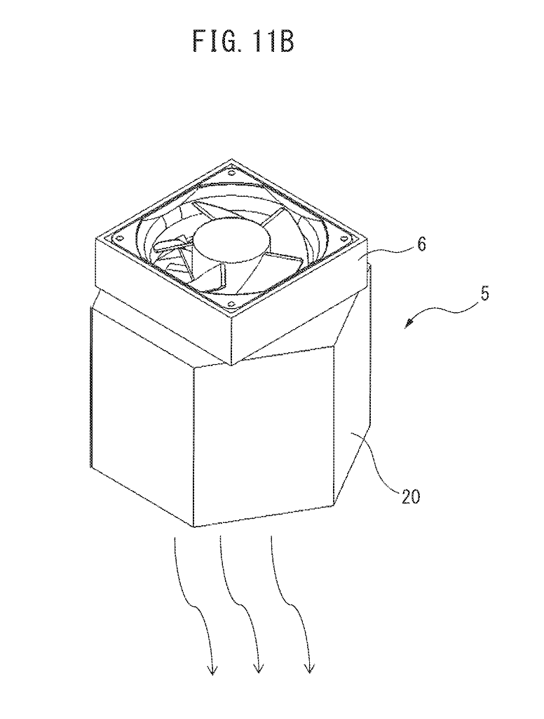

FIG. 11A is a perspective view of a reactor according to an eighth embodiment, and FIG. 11B is another perspective view of the reactor shown in FIG. 11A. In FIG. 11A, a reactor 5 is oriented such that an axial direction of the reactor 5 coincides with the horizontal direction. In FIG. 11B, the reactor 5 is oriented such that the axial direction of the reactor 5 coincides with the vertical direction. In the drawings, a cooling fan 6 is attached to an end surface of an outer peripheral iron core 20.

When the cooling fan 6 or the cooling fans 6a to 6c is driven, air flows from the cooling fan 6 or the cooling fans 6a to 6c through the through holes and gaps 101 to 103 in the axial direction of the reactor 5. Thus, the reactor 5 has further increased cooling effect. Furthermore, the eighth embodiment requires only the single cooling fan 6.

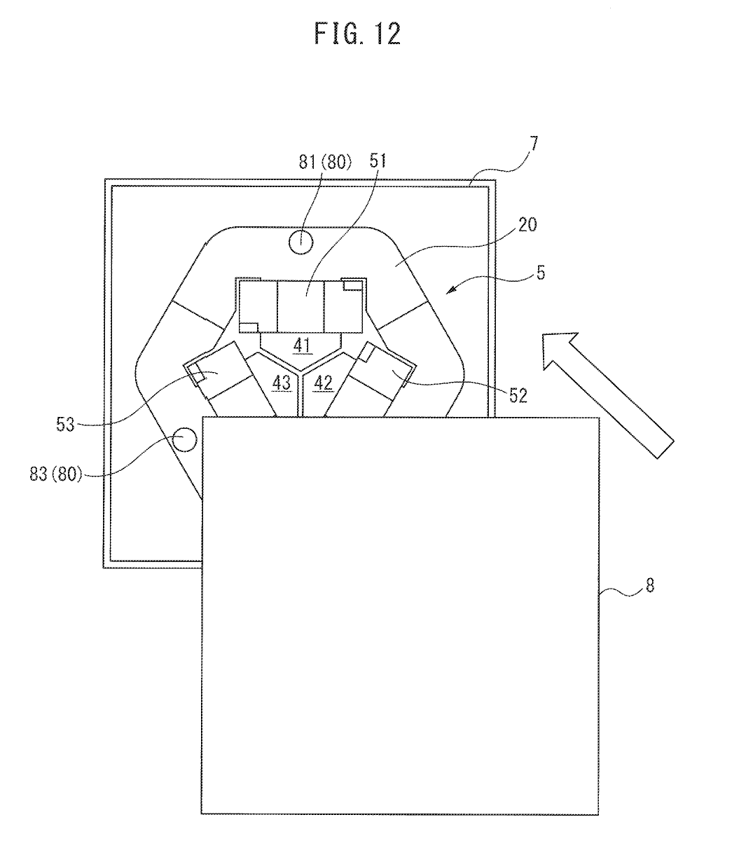

FIG. 12 is a perspective view of a reactor according to a ninth embodiment. In FIG. 12, a reactor 5 is contained in a housing 7. The housing 7 contains the reactor 5 having cooling units 80. After or before the reactor 5 is disposed in the housing 7, the housing 7 is filled with a predetermined amount of coolant. After the housing 7 is closed with a lid 8, the reactor 5 is driven. Therefore, the coolant contained in the housing 7 contributes to cooling the reactor 5 more efficiently.

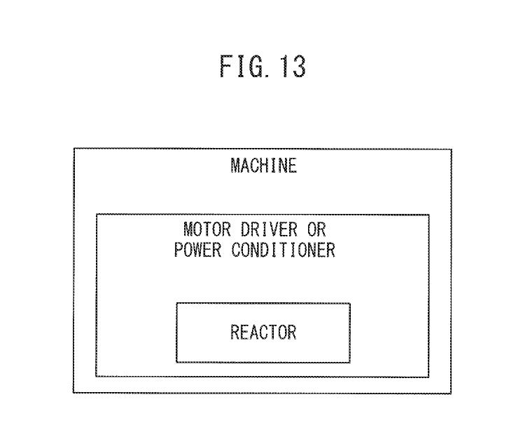

FIG. 13 is a block diagram of a machine including a reactor. In FIG. 13, a reactor 5 is used in a motor driver or a power conditioner. The machine includes the motor driver or the power conditioner. In this case, the motor driver, power conditioner, machine and the like having the reactor 5 can be easily provided. The scope of the present invention includes appropriate combinations of some of the above-described embodiments.

### EMBODIMENTS OF DISCLOSURE

A first embodiment provides a reactor (5) that includes an outer peripheral iron core (20), and at least three core coils (31-36) contacting or connected to an inner surface of the outer peripheral iron core. Each of the core coils includes a core (41-46) and a coil (51-56) wound onto the core. The reactor (5) further includes a cooling unit (80) disposed in an end surface of the outer peripheral iron core, for cooling the outer peripheral iron core.

According to a second embodiment, in the first embodiment, the cooling unit includes at least one through hole formed so as to extend in the axial direction of the outer peripheral iron core.

According to a third embodiment, in the second embodiment, the minimum width of the outer peripheral iron core excluding the through hole is more than half of the width of the core.

According to a fourth embodiment, the second or third embodiment further includes a cooling fan disposed inside the at least one through hole.

According to a fifth embodiment, in any one of the first to third embodiments, the cooling unit further includes a tube (71-73) inserted into the at least one through hole.

According to a sixth embodiment, in the fifth embodiment, an end of the tube is closed with a lid (71a-73a, 71b-73b), and the tube is filled with coolant.

According to a seventh embodiment, the first or second embodiment further includes a housing for containing the outer peripheral iron core, the housing being filled with coolant.

According to an eighth embodiment, any one of the first to seventh embodiments further includes a central core (10) disposed at the center of the outer peripheral iron core. The cooling unit includes at least one through hole formed in the central core so as to extend in the axial direction.

A ninth embodiment provides a motor driver including the reactor according to any one of the first to eighth embodiments.

A tenth embodiment provides a machine including the motor driver according to the ninth embodiment.

An eleventh embodiment provides a power conditioner including the reactor according to any one of the first to eighth embodiments.

A twelfth embodiment provides a machine including the power conditioner according to the eleventh embodiment.

### Advantageous Effects of the Embodiments

According to the first embodiment, since the cooling unit is disposed in the outer peripheral iron core, the reactor can be efficiently cooled with a simple structure.

According to the second embodiment, since heat dissipates through the through hole, the reactor can be cooled with high efficiency.

According to the third embodiment, even when the through hole is formed in the outer peripheral iron core, the outer peripheral iron core reliably has an area through which the magnetic flux can pass. Therefore, the cooling unit has no effect on the magnetic characteristics of the reactor.

According to the fourth embodiment, air flowing from the cooling fan through the through hole further enhances the cooling effect.

According to the fifth embodiment, heat can dissipate through the tube. Furthermore, coolant can flow through the tube.

According to the sixth embodiment, the coolant cools the reactor with higher efficiency.

According to the seventh embodiment, the coolant contained in the housing cools the reactor more efficiently.

According to the eighth embodiment, since heat dissipates through the through hole formed in the central core, the reactor can be cooled efficiently.

According to the ninth to twelfth embodiments, the motor driver, power conditioner and machine having the reactor can be easily provided.

The present invention is described above with reference to the preferred embodiments, but it is apparent for those skilled in the art that the above-described and other various modifications, omissions and additions can be performed without departing from the scope of the present invention.

What is claimed is:

1. A reactor comprising:
an outer peripheral iron core;
at least three core coils contacting or connected to an inner surface of the outer peripheral iron core,
each of the core coils including a core and a coil wound onto the core; and
a cooling unit disposed in an end surface of the outer peripheral iron core, for cooling the outer peripheral iron core.

2. The reactor according to claim 1, wherein the cooling unit includes at least one through hole formed so as to extend in an axial direction of the outer peripheral iron core.

3. The reactor according to claim 2, wherein the minimum width of the outer peripheral iron core excluding the through hole is more than half of the width of the core.

4. The reactor according to claim 2, further comprising a cooling fan disposed inside the at least one through hole.

5. The reactor according to claim 1, wherein the cooling unit further includes a tube inserted into the at least one through hole.

6. The reactor according to claim 5, wherein an end of the tube is closed with a lid, and the tube is filled with coolant.

7. The reactor according to claim 1, further comprising a housing for containing the outer peripheral iron core, the housing being filled with coolant.

8. The reactor according to claim 1, further comprising:
a central core disposed at the center of the outer peripheral iron core, wherein
the cooling unit includes at least one through hole formed in the central core so as to extend in an axial direction.

9. A motor driver comprising the reactor according to claim 1.

10. A machine comprising the motor driver according to claim 9.

11. A power conditioner comprising the reactor according to claim 1.

12. A machine comprising the power conditioner according to claim
